(19) United States
(12) Patent Application Publication
(10) Pub. No.: US 2017/0334059 A1
(43) Pub. Date: Nov. 23, 2017

(54) Convertible Elongated Stepping Bench

(71) Applicant: Gary Moffat, Arlington, WA (US)

(72) Inventor: Gary Moffat, Arlington, WA (US)

(21) Appl. No.: 15/603,264

(22) Filed: May 23, 2017

Related U.S. Application Data
(60) Provisional application No. 62/410,600, filed on Oct. 20, 2016.
(60) Provisional application No. 62/340,212, filed on May 23, 2016.

(51) Int. Cl. B25H 1/16; A47C 16/04; A47C 12/02; B25H 1/04; A47C 11/00

(52) U.S. Cl. CPC B25H 1/16; B25H 1/04; A47C 11/00; A47C 12/02; A47C 16/04

(57) ABSTRACT

A convertible elongated stepping bench configured to be uses as a standard step stool or a low profile sitting or kneeling platform. The bench includes an elongated rectangular, lightweight rigid frame with two opposite leg assemblies. Each leg assembly includes two pivotally attached rigid legs. Each leg is pivotally attached to a corner of the rigid frame. The leg assemblies pivot between a diagonally downward position that supports the rigid frame in an elevated position over the ground or fold inward, under and rigid frame. Attached to the outside surface of each leg near the pivoting hinge is a foot pad. Extending downward from the bottom surface of the rigid frame are at least two leg stops. When the legs are folded inward, the distal end of each leg rests against a leg stop so that the leg's axis is parallel to the rigid frame's longitudinal axis. When the leg assemblies are folded inward and the bench is placed on the ground, the feet pads on the legs supports the bench on the ground.

This utility patent application is based upon and claims the filing date benefits of U.S. provisional patent application (62/340,212) filed on May 23, 2016 and U.S. provisional patent application (62/410,600) filed on Oct. 20, 2016.

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

### Field of the Invention

This invention pertains to lightweight, portable work benches, and more particular to work benches that can be used as a standing stepping stool and or as a low profile sitting or kneeling platform.

### Description of the Related Art

Portable, elongated stepping stools are commonly used as stepping stools by workers to reach objects or surfaces above the worker's normal reach. While ladders may also be used to reach objects or surfaces, elongated stepping stools are useful when the worker needs to reach long objects or surfaces. Elongated stepping stools are typically 16 to 22 inches in height and 12 to 48 inches in length.

For some occupations, an elongated stepping stool is useful for some tasks but too high to be used as a sitting or kneeling platform when working on objects or surfaces near the floor or ground. For example, an automobile body repair worker needs to stand on an elongated stepping stool when working on the roof of an automobile. When the worker needs to work on an object or surface close to the ground, such as an automobile bumper, fender or wheel, the worker must sit or kneel on the floor or mat.

What is needed is an elongated stepping bench that a worker can stand on to work on elevated objects or surfaces that easily converts to a low profile, sitting or kneeling platform that allows the worker to sit, kneel or lay on the platform next to the ground.

### SUMMARY OF THE INVENTION

These and other objects are met by a convertible elongated stepping bench that easily converts into a low profile sitting or kneeling platform. A bench that easily converts into both configurations is useful in occupations or hobbies which allow user stand on the bench to reach elevated structures or surfaces, allows the user to sit comfortably and reach structures or surfaces two to four feet off the ground, or allow the user to comfortably squat or kneel to reach structures or surfaces less than two feet off the ground.

The bench includes an elongated rectangular, lightweight rigid frame with two leg assemblies located at the opposite ends of the rigid frame. Each leg assembly includes two rigid legs attached to hinges located at each corner of the rigid frame. The leg assemblies pivot on the opposite ends of the rigid frame from a diagonally aligned downward position that supports the rigid frame in an elevated position over the ground or pivot inward under the rigid frame and substantially parallel to the rigid frame's longitudinal axis.

Attached to the outside surface and near the end of each leg is a foot pad. Extending downward from the bottom surface of the rigid frame are two leg stops. When the leg assemblies are folded inward, the middle section of each leg rests against a leg stop so that the leg's axis is substantially parallel to the rigid frame's longitudinal axis. When the leg is folded inward and the workbench is laid horizontally on the ground, the four feet pads on the four legs support the workbench on the ground.

Attached to the top surface of the rigid frame is an optional foam pad.

Attached to one end of the rigid frame is an optional handle.

In one embodiment, two caster wheel assemblies may be attached to the opposite ends of the rigid frame enabling the bench to be used as a rolling creeper.

### DESCRIPTION OF THE DRAWINGS

FIG. 1 is perspective view of a convertible elongated stepping bench shown in an extending elevated configuration for use as a stepping stool.

FIG. 2 is a convertible lightweight stepping bench shown in a folded configuration for use as a low profile sitting or kneeling platform.

FIG. 3 is a top plan view of the convertible elongated stepping shown in FIG. 1.

FIG. 4 is a side elevational view of the convertible elongated stepping bench shown in FIGS. 1 and 3.

FIG. 5 is a top plan view of the convertible elongated stepping bench shown in FIG. 2.

FIG. 6 is a side elevational view of the convertible elongated stepping bench shown in FIGS. 2 and 5.

FIG. 7 is a top plan view of the stepping bench with two optional handles attached to the opposite ends.

FIG. 8 is a side elevational view of the stepping bench shown in FIG. 7.

FIG. 9 is a top plan view of the stepping bench in folded configuration with a two caster wheel extensions attached to the opposite ends.

FIG. 10 is a side elevational view of the stepping bench shown in FIG. 9.

FIG. 11 is a partial perspective view of the stepping bench shown in FIGS. 9 and 10 showing the wheel extension arm assembly attached to one end of the stepping bench.

### DESCRIPTION OF THE PREFERRED EMBODIMENT(S)

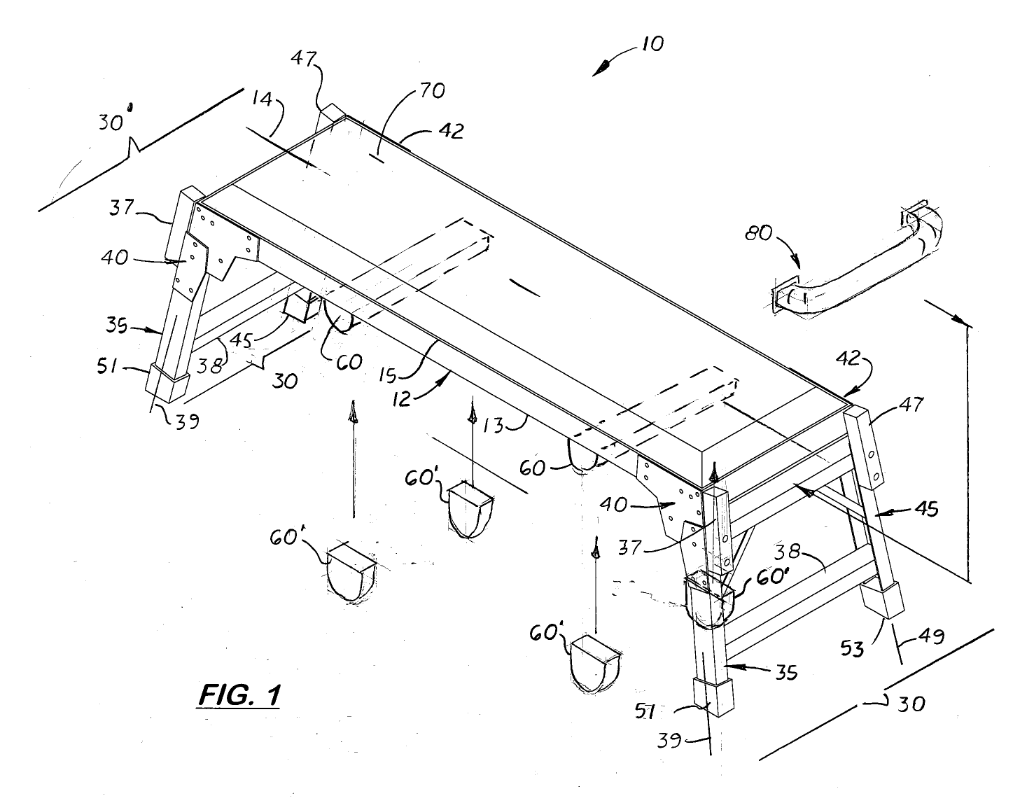

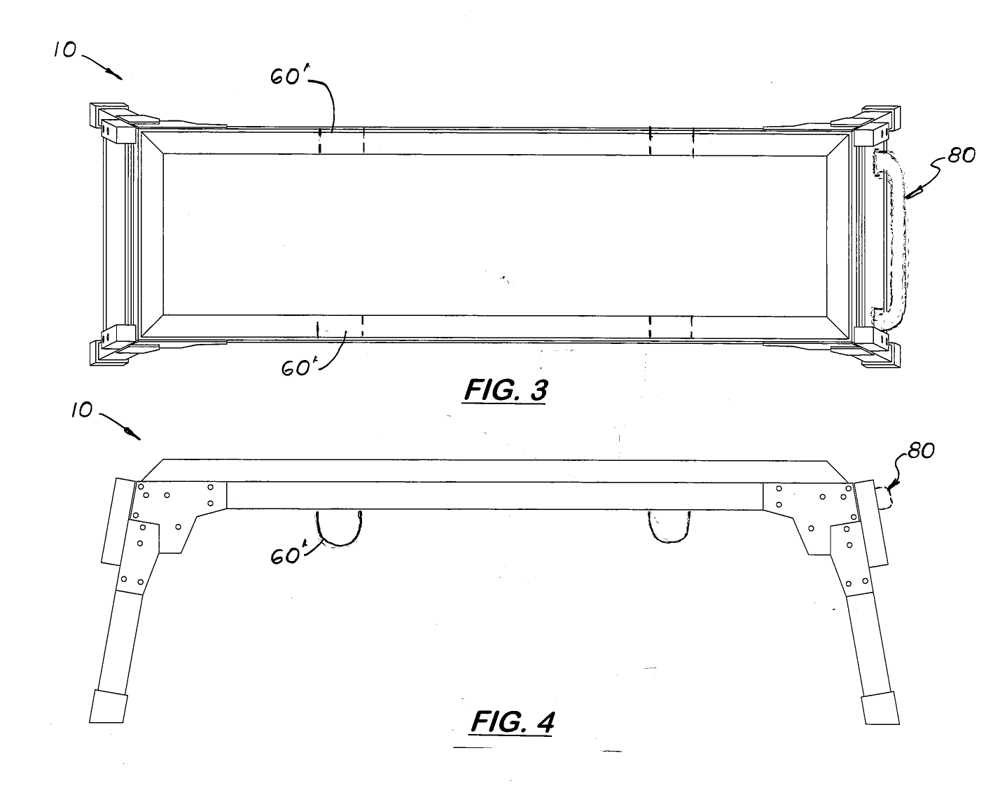

Shown and described herein is a convertible, lightweight stepping bench 10 that can be also used as a low profile sitting or a kneeling platform. The bench 10 includes an elongated rectangular, lightweight rigid frame 12 with two opposite leg assemblies 30. Each leg assembly 30, includes two pivotally attached rigid legs 35, 45. Extending between the two legs 35, 45 is a rigid cross member 38. Each leg 35, 45 is pivotally attached to a corner of the rigid frame 12 via a hinge assembly 40. The leg assemblies 30 pivots between a diagonally downward position that supports the rigid frame 12 in an elevated position over the ground or folded inward, under and rigid frame 12 as shown in FIGS. 1, 2 and 3.

Attached to the outside surface of each leg 35, 45 near the hinge assembly 40 is a foot pad 37, 47, respectively. When each leg 35, 45 are folded inward, the foots pads 37, 47 are designed to support the beach 10 in a horizontal orientation on a support surface. Attached and extending downward from the bottom surface 13 of the rigid frame 12 are at least two leg stops 60. In the embodiment shown in FIGS. 1, the legs stops 60 are two elongated, half-spherical structures. In another embodiment as shown in FIG. 1, the leg stops (indicated by reference number 60′ are four narrow, half-spherical pads. The thickness of the legs stops 60, 60′ are sufficient to support the legs 35, 45 in a horizontal orientation when they are folded inward and a user stands or sits on the bench 10. The size and shape of the leg stop 60, 60′ is sufficient so that when the leg 35, 45 is folded inward, the leg's axis 39, 49, respectively, is substantially parallel to the rigid frame's longitudinal axis 14. The leg stops 60, 60 are also located on the bottom of the rigid frame 12 so that when the legs 35, 45 are folded inward, the middle section of each leg 35, 45 rests against a leg stop 60 or 60′.

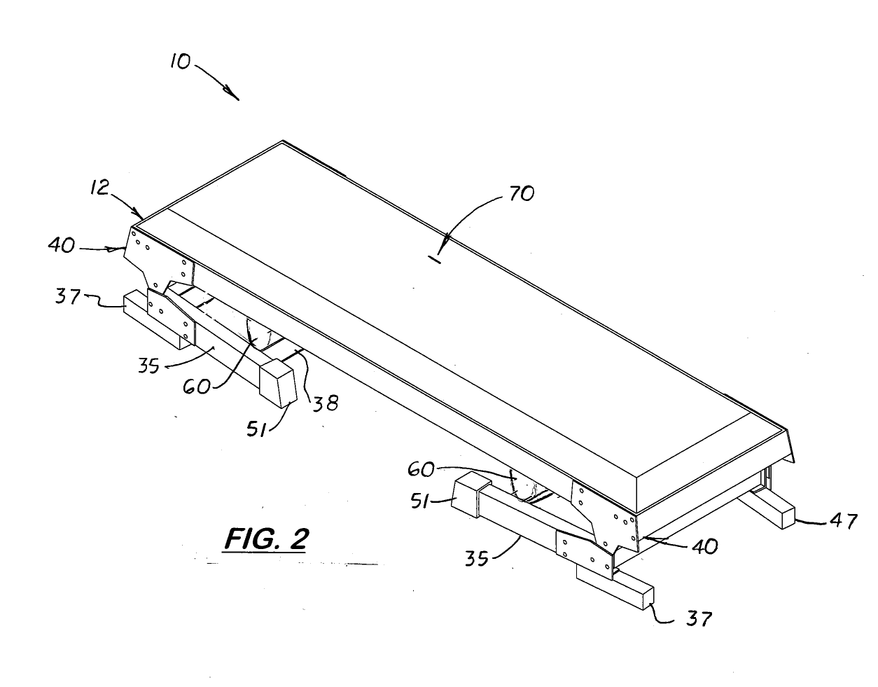

When the two leg assemblies 30, 30′ are folded inward and the bench 12 is placed on a support surface, the foot pads 37, 47 and the foot caps 38, 38 on the legs 35, 45, respectively supports the rigid frame 12 on the support surface as shown in FIGS. 2 and 6.

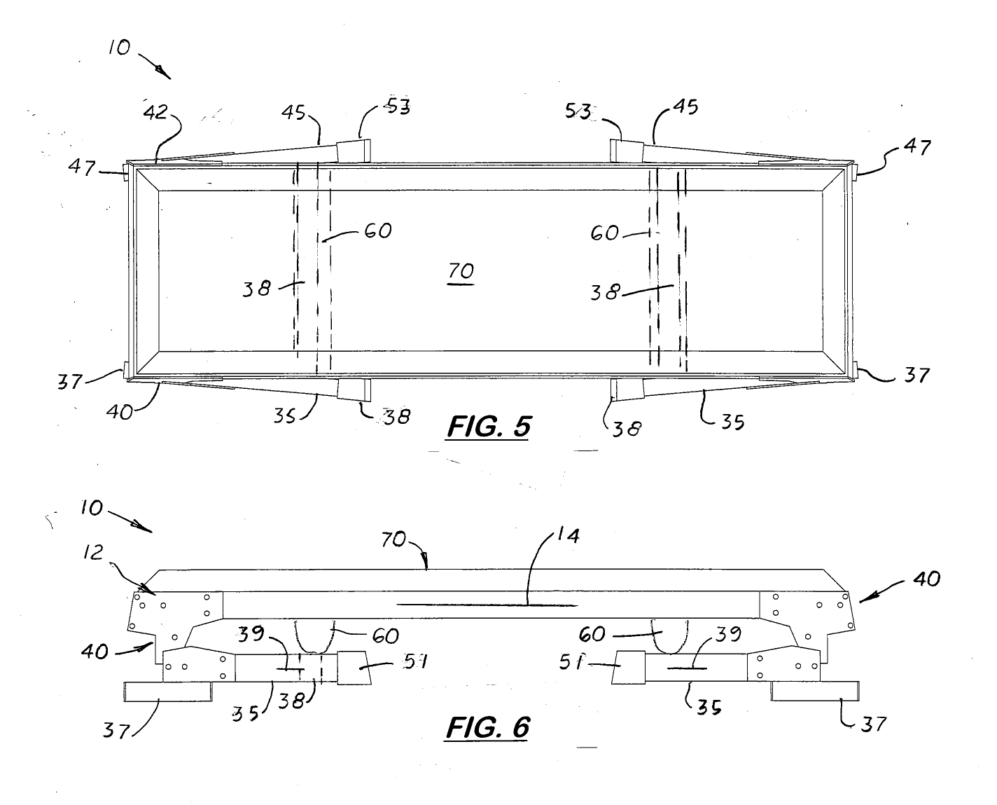

As shown in FIGS. 5, 6 and 7, 8, the legs stops 60, and 60′ respectively, are located so that the cross member 38 on each leg assembly presses against the leg stop 60, 60′. Leg stop 60 has a curved lower surface and is approximately 2 to 2½ inches thick and 10 to 18 in length. Leg stops 60′ are approximately 2 to 2½ inches thick and 1½ inches to 3 inches in length. It should be understood, however, that the invention is not limited to leg stops 60, 60′ has shown and described, herein.

The rigid frame 12 is 10 to 18 inches in width, 10 to 18 inches in height, and 30 to 48 inches in length. The rigid frame 12 is made of aluminum and 1 to 2 inches thick. Attached to the top surface 15 of the rigid frame 12 is an optional, closed-cell foam pad 70. The foam pad 70 is approximately 1 inch thick.

The legs 35, 45 are approximately 12 inches in length. When extended downward, the longitudinal axis 39, 49 of each leg 35, 45, respectively, is aligned outward 10 to 25 degrees from the vertical axis (or 65 to 80 degrees from the rigid frame's longitudinal axis 14). The legs rests 60 are transversely aligned and located on the bottom surface 13 of the rigid frame 12 so that the legs press against the leg rests when folded inward. The legs rests 60 are approximately 2 inches thick. The foot caps 51, 53 and distal ends of the legs 35, 45 do not cross. The foot pads 37, 47 are approximately 1 inch wide, 1 inch thick and 3 inches in length.

When the legs 35, 45 are extended, the top surface of the foam pad 70 is approximately 15 inches off the ground. When the legs 35, 45 are folded inward, the top surface of the foam pad 70 is approximately 8 inches off the ground. The foam pad 70 is made of closed cell, nitrile foam rubber.

Attached to one end of the rigid frame 12 is an optional handle 80. In the embodiment shown in FIGS. 1, 3 and 4, one handle 80 is attached that extends laterally from the frame 12.

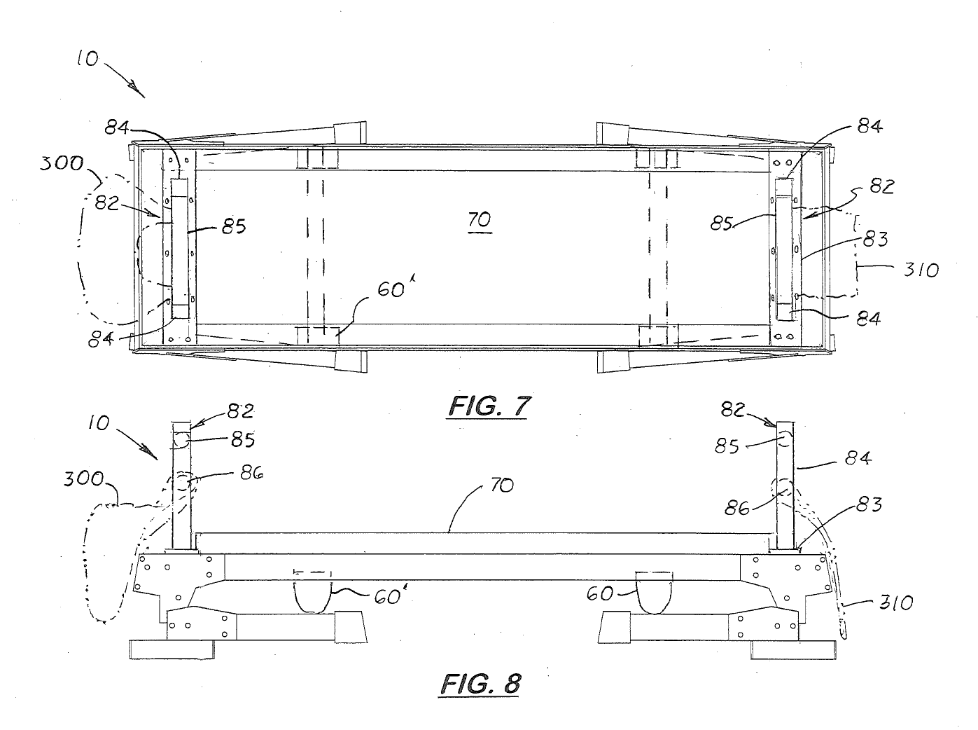

FIGS. 7 and 8 is top plan view and a side elevational view, respectively, of the stepping bench 10 with two optional, vertically aligned handles 82 attached to the bench's opposite ends. While two handles 82 are illustrated, it should be understood that the bench 10 could be manufactured with one vertically aligned handle 82. Each vertical handle 82 includes a flat lower plate 83 securely attached to the rigid frame 12. Extending upward from the plate 83 are two vertical members 84. Extending between the two vertical members 84 is at least one horizontal member 85. In embodiment shown in FIG. 8 also attached is a second horizontal member 86. During use, a trash bag or tool pouch 300 or towel 310 may be attached to the handles 82.

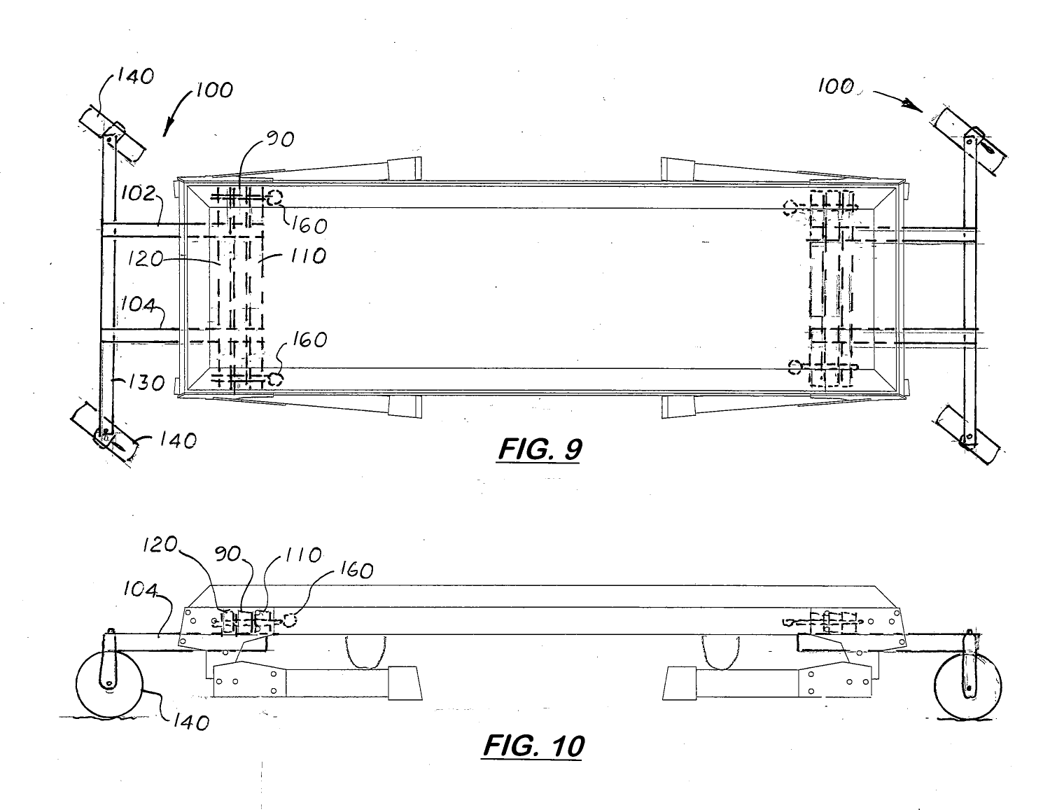

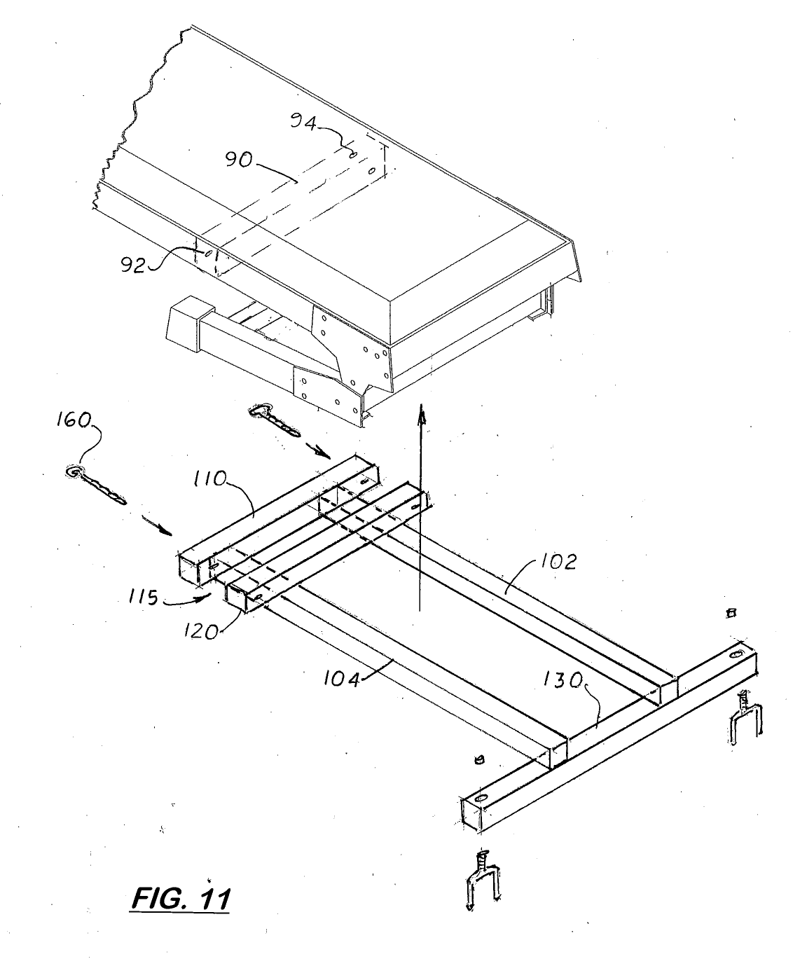

FIGS. 9-11 show an alternative accessory 100 that may be used with the extension stool 1 and enables the rigid frame 12 when in a folded configuration to be used as a rolling creeper. The rigid frame 12 is modified to includes one transversely aligned, horizontal brace member 90 located near and permanently attached to each end of the rigid frame 12. Peg holes 92, 94 (see FIG. 11) are formed on each end of the brace member 90. Each accessory 100 includes two longitudinal members 102, 104, two parallel frame members 110, 120 attached to the two longitudinal members 102, 104. The frame members 110, 120 are perpendicularly aligned and mounted on top surface of the two longitudinal members 102, 104. The frame members 110, 120 are sufficiently spaced apart so that the brace member 90 attached to the stool 12 may fit in the gap 115 located between them. Peg holes are formed on the opposite ends of each frame member 110, 120 that are aligned and registered with the peg holes 92, 94, respectively, formed on the brace member 90 when the brace member 90 is inserted into the gap 115 and between the two frame members 110, 120. Pins 160 may be inserted into the pegs holes 92, 94 to connect the brace member 90 to the two frame members 110, 120.

The longitudinal members 102, 104 extend beyond the end of the rigid frame 12 Perpendicular aligned amounted on the bottom surface of the longitudinal members is a caster wheel arm 130. Mounted on the distil ends of the caster wheel arm 130 is a rotating caster wheel 140. The length of the caster wheel arm 130 is sufficient so that the caster wheels 140 are located outside the stool's side frame members.

During use, the legs 35, 45 are folding inward under the rigid frame 12. The diameter of the caster wheels 140 is sufficient so that the legs 35, 45 are above the ground thereby enabling the bench 10 to roll over the ground.

The rigid frame 12 and the legs 35, 46, and cross members 38 are made of aluminum. The two hinges 40 are made or steel. The foot pads 37, 47 and leg stops 60, 6′ are made of high density, marine grade plastic, also known as HDPE, incorporated by reference herein. An example of HDPE that may be used is sold under the trademark STARBOARD by King Plastic Corporation, located in North Port, Fla.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. A convertible elongated stepping bench, comprising:
a. an elongated rectangular, lightweight rigid frame with four corners, a first end, a second end, a top surface and a bottom surface;
b. a hinge attached to each corner of said rigid frame;
c. two leg assemblies attached to said pair of said hinges located on said first end and said second end of said rigid frame, each leg assembly includes two pivotally legs, an upper transverse member and a lower transverse member, each said leg includes an upper end a lower end and an outside surface;
d. a foot pad attached to each said outside surface of each said leg near the pivoting hinge;
f. at least two leg stops extending downward from said bottom surface of said rigid frame, said each said leg stop being configured to press against said legs on a leg assembly when said leg assembly are folding inward and align said legs substantially parallel to said rigid frame; and,
g. a foam pad attached to said top surface of said rigid frame.

2. The bench, as recited in claim 1, further including a handle attached to said rigid frame.

3. The bench, as recited in claim 2, wherein said handle extends laterally from said rigid frame.

4. The bench, as recited in claim 2, wherein said handle extends upward from said rigid frame.

5. The bench, as recited in claim 1 further included two caster wheel assemblies mounted on the opposite ends of said rigid frame.

6. The bench, as recited in claim 1, wherein said leg stop is made of high density marine plastic.

7. The bench, as recited in claim 1, wherein said foot pad is made of high density marine plastic.

8. The bench, as recited in claim 1, wherein each leg assembly includes a cross member, said cross member and leg stop are aligned so that said cross member presses against said leg stop when folding inward.

9. The bench as recited in claim 1, further including a leg cap attached to said distal end of said leg;

10. The bench, as recited in claim 1, wherein said leg stop is elongated and configured to extends transversely under said rigid frame.
